(19) United States
(12) Patent Application Publication
(10) Pub. No.: US 2016/0314509 A1
(43) Pub. Date: Oct. 27, 2016

(54) AUDIO UPLOADING AND SHARING SERVICE

(71) Applicant: Minty Networks, LLC, Alpharetta, GA (US)

(72) Inventors: Albert Einstein Renshaw, Alpharetta, GA (US); Connor Matthew Duggan, Victoria (CA)

(21) Appl. No.: 14/696,045

(22) Filed: Apr. 24, 2015

(51) Int. Cl. G06Q 30/06; G06Q 50/00; H04L 29/08

(52) U.S. Cl. CPC G06Q 30/0601; H04L 67/06; G06Q 50/01

(57) ABSTRACT

Technologies are described herein providing technologies for audio uploading and sharing using a social collaboration application. In some examples, the collaboration application is a social collaboration application configured to allow users to share information in a social context. In various configurations, a collaboration application receives an input to share a portion of an audio file. The portion of the audio file is provided as an information feed to one or more users. The information feed may include a purchase feature whereby a user may purchase the right to download and play the audio file.

### BACKGROUND

Collaboration and information sharing services (“collaboration services”) are becoming increasingly common. Collaboration services can provide users a way to communicate with other users. A listing of users are sometimes narrowed to specific users that a user identifies as one to which communication can occur. The users can share their status, provide news about their life and family, share pictures, and other information they desire to share with their fellow users.

It is with respect to these and other considerations that the disclosure made herein is presented.

### SUMMARY

The following detailed description is directed to technologies for audio uploading and sharing using a social collaboration application. In some examples, the collaboration application is a social collaboration application configured to allow users to share information in a social context. In various configurations, a collaboration application receives an input to share data. The collaboration thereafter receives an input that the data to be shared is an audio file. In some examples, the audio file is a music file. The collaboration application retrieves a listing of music files from a music library.

The collaboration application receives an input of the music file to be shared and receives a selection of a portion of the music file to be shared. The collaboration application thereafter retrieves additional information and causes the placement of the selected portion of the music file and additional information into an information feed of the user as well as other users that receive information feeds from the user. A user that receives the information feed from the user that posts the portion of the music file may thereafter play the portion of the music file.

It should be appreciated that the above-described subject matter may be implemented as a computer-implemented method, computer-controlled apparatus, a computer process, a computing system, or as an article of manufacture such as a computer-readable medium. These and various other features will be apparent from a reading of the following Detailed Description and a review of the associated drawings.

This Summary is provided to introduce a selection of technologies in a simplified form that are further described below in the Detailed Description. This Summary is not intended to identify key features or essential features of the claimed subject matter, nor is it intended that this Summary be used to limit the scope of the claimed subject matter. Furthermore, the claimed subject matter is not limited to implementations that solve any or all disadvantages noted in any part of this disclosure

### BRIEF DESCRIPTION OF THE DRAWINGS

FIG. 1 is a system diagram showing one illustrative operating environment that may be used to implement various embodiments described herein.

FIG. 2 is user interface (“UI”) diagram showing a user interface for use in audio uploading and sharing using a social collaboration application.

FIG. 3 is a UI diagram showing a user interface with a data type selection UI.

FIG. 4 is a UI diagram showing the audio library, which may be generated when an input is received to insert an audio file into the information feed.

FIG. 5 is a UI diagram showing an audio insert interface.

FIG. 6 is a UI diagram showing the UI of FIG. 2 after a post interface is selected.

FIG. 7 is a UI diagram showing a UI associate with a different user device after the post interface is selected

FIG. 8 is a flow diagram showing aspects of a method for audio uploading and sharing using a social collaboration application.

FIG. 9 is a flow diagram showing aspects of a method for audio uploading and sharing using a social collaboration application in reference to the collaboration application server.

FIG. 10 is a flow diagram showing aspects of a method for audio uploading and sharing using a social collaboration application in reference to a second user device.

FIG. 11 illustrates an illustrative computer architecture for a device capable of executing the software components described herein for audio uploading and sharing using a social collaboration application.

FIG. 12 illustrates an illustrative distributed computing environment capable of executing the software components described herein for audio uploading and sharing using a social collaboration application.

### DETAILED DESCRIPTION

Embodiments of the disclosure presented herein encompass technologies for audio uploading and sharing using a social collaboration application. In general, a user may initiate a social collaboration application on their computing device. The social collaboration application may allow the user to receive and share information from and to other users. The user may wish to share all or a portion of an audio file with another user through the social collaboration application. The social collaboration application may provide a user interface through which an insertion command may be received. Once selected, the user may be presented with a listing of their current audio files. A selection of an audio file may be received. Information regarding the audio file may be retrieved and inserted into an information feed of the user and, in some examples, into information feeds of other users. These and other aspects are described in more detail in reference to various figures.

In the following detailed description, references are made to the accompanying drawings that form a part hereof, and in which are shown by way of illustration specific embodiments or examples. Referring now to the drawings, aspects of an exemplary operating environment and some example implementations provided herein will be described.

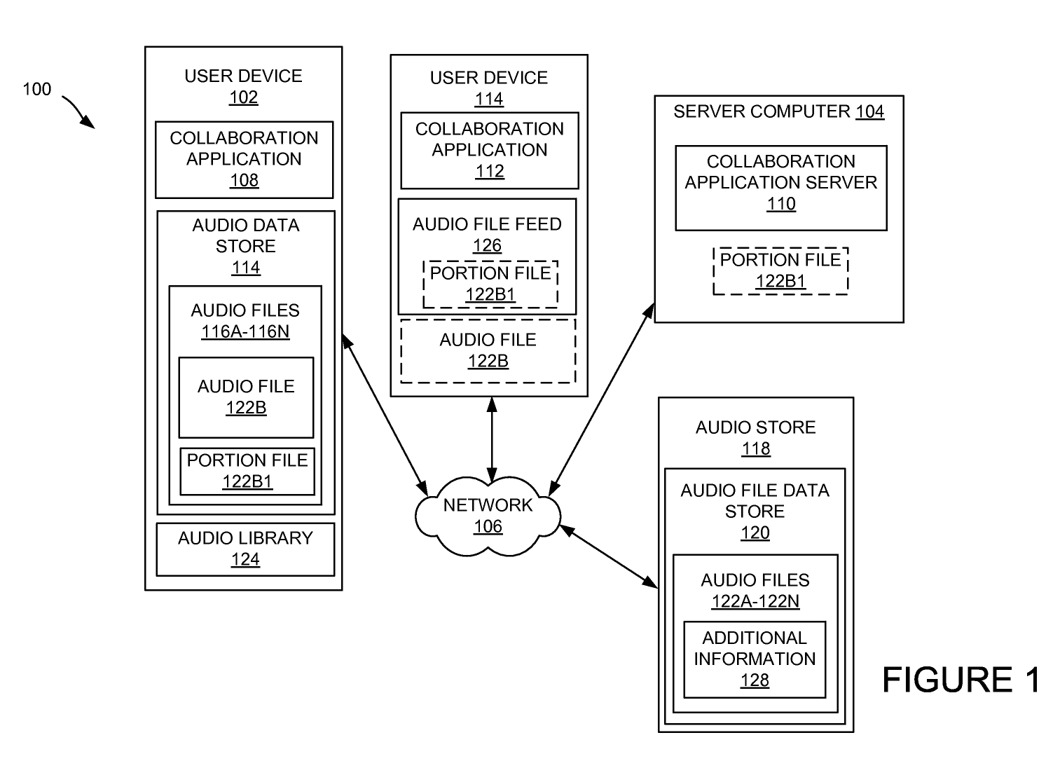

FIG. 1 is system diagram showing one illustrative operating environment 100 that may be used to implement various embodiments described herein. The operating environment 100 may include a user device 102 and a server computer 104. The user device 102 and/or the server computer 104 are not limited to any particular type or configuration of computing platform. Further, the user device 102 and/or the server computer 104 may be one or more computing devices that, when implemented together, may be used as a user device 102 and/or a server computer 104. The user device 102 and/or the server computer 104 may be implemented in various forms, including, but not limited to, a mobile device, a cell phone, a tablet computer, a desktop computer, a laptop computer, and the like. The presently disclosed subject matter is not limited to any particular implementation.

The user device 102 may be placed in communication with the server computer 104 using a network 106. FIG. 1 illustrates one user device 102, one network 106, and one server computer 104. It should be understood, however, that some implementations of the operating environment 100 include multiple user devices 102, multiple networks 106, and/or multiple server computers 104. The illustrated examples described above and shown in FIG. 1 should be understood as being illustrative, and should not be construed as being limiting in any way. It should be understood that the concepts and technologies disclosed herein are not limited to an operating environment 100 connected to a network or any external computing system, as various embodiments of the concepts and technologies disclosed herein can be implemented locally on the user device 102 and/or the server computer 104.

The user device 102 may be configured to initiate and execute a collaboration application 108. In some examples, the collaboration application 108 may be a social collaboration application configured to allow the sharing of information in a social context between two or more users. Although not limited to any particular type of information, in some examples, the information may be information about the personal life of the user, a statement or status that the user wishes to share, pictures, and other types of information. The presently disclosed subject matter is not limited to any particular type of information.

In some examples, once executed by the user device 102, the collaboration application 108 may initiate a communication with a collaboration application server 110 executed by the server computer 104. The collaboration application server 110 may, among other tasks, act as a central coordinating service for the execution of the collaboration application on various devices, such as the collaboration application on the user device 102 and a collaboration application 112 on a user device 114. It should be noted that the presently disclosed subject matter is not limited to implementations in which the collaboration application server 110 is used. In some examples, some or all of the functions provided by the collaboration application server 110 may be provided by other services, such as the collaboration application 108 and/or the collaboration application 112.

The collaboration application 108 and/or the collaboration application 112 may communicate with the collaboration application server 110 to send and receive various types of information. For example, the collaboration application 108 may receive an input from a user regarding comments about an event. The comments may be transmitted to the collaboration application server 110, which in turn determines which collaboration applications the information should be provided. In this example, the collaboration application server 110 may determine that the comments about an event should be transmitted to the collaboration application 112. The collaboration application 112 may receive the information from the collaboration application server 110 and display the information.

The user device 102 may also include an audio data store 114. The audio data store 114 may have stored therein one or more audio files 116A-116N (hereinafter referred to collectively and/or generically as “the audio files 116” and individually as “the audio file 116A,” and the like). The audio files 116 may be various types, including music, sound clips, and the like. The presently disclosed subject matter is not limited to any particular type of the audio files 116. The audio files 116 may be stored in various data formats, including, but not limited to “.mp3,” “.wav,” “.dct” and the like. The presently disclosed subject matter is not limited to any particular type of data format.

A user may have received the audio files 116 using various means. For example, a user may have purchased the right to download and listen to the audio files 116 using an audio store 118. The audio store 118 may have an audio file data store 120. The audio file data store 120 may have stored therein audio files 122A-122N (hereinafter referred to collectively and/or generically as “the audio files 122”). The right to download and play one or more of the audio files 122 may be purchased using the audio store 118. In one example, a user may have purchased the right to download and play the audio file 122B from the audio store 118. Upon sufficient payment, the user may be able to download the audio file 122B from the audio store 118. The audio files 116 may be comprised of the audio files 122 purchased and/or downloaded using the audio store 118.

It should be noted that although the presently disclosed subject matter is described in terms of a single audio store 118, the audio files 116 may be received in other manners, including using other audio stores (not illustrated) or audio files generated outside of a third-party service (such as audio recorded using a microphone). The presently disclosed subject matter is not limited to any particular implementation.

Returning to FIG. 1, a user may wish to share the audio file 122B on an information feed of the collaboration application, described in more detail in the figures below). The collaboration application 108 may receive an input indicating that an audio file is to be shared. The collaboration application 108 may query the audio data store 114 to determine audio files 116 available for sharing. The query may cause the generation of an audio library 124 for display in the collaboration application 108. The collaboration application 108 may receive an input indicating that the audio file 122B is to be the file to be shared. The collaboration application 108 may then display information about the audio file 122B to the user. The collaboration application 108 may then receive an input to post the audio file 122B to the information feed of the user.

The audio store 118 may be queried to determine additional information 128 about the audio file 122B. The additional information 128 may be metadata or other data associated with the audio file 122B. For example, the additional information 128 may include, but may not be limited to, album cover artwork, pricing information, information on how to purchase the right to download and listen to the audio file 122B, and the like. The additional information 128 determined by the collaboration application 108 and received from the audio store 118 may be transmitted to the collaboration application server 110. The collaboration application server 110 may receive the additional information 128 and transmit audio file feed 126 to be shared in the collaboration application 108 or the collaboration application 112.

The audio file feed 126 may include a portion of the audio file 122B as well as the additional information 128, generated as a portion file 122B1, as described above. The portion file 122B1 may be uploaded to the server computer 104 for access by the collaboration application 112 operating on the user device 114. A user using the user device 114 may see the portion file 122B1 inserted into an information feed in the collaboration application 112. The user may be able to play the audio file feed 126 and or purchase the right to download and play the portion file 122B1. If purchased, the audio file 122B may be downloaded from the audio store 118 to the user device 114. A user may thereafter be able to play the audio file 122B using, for example, the user device 114. Additional aspects are described in more detail in the following figures.

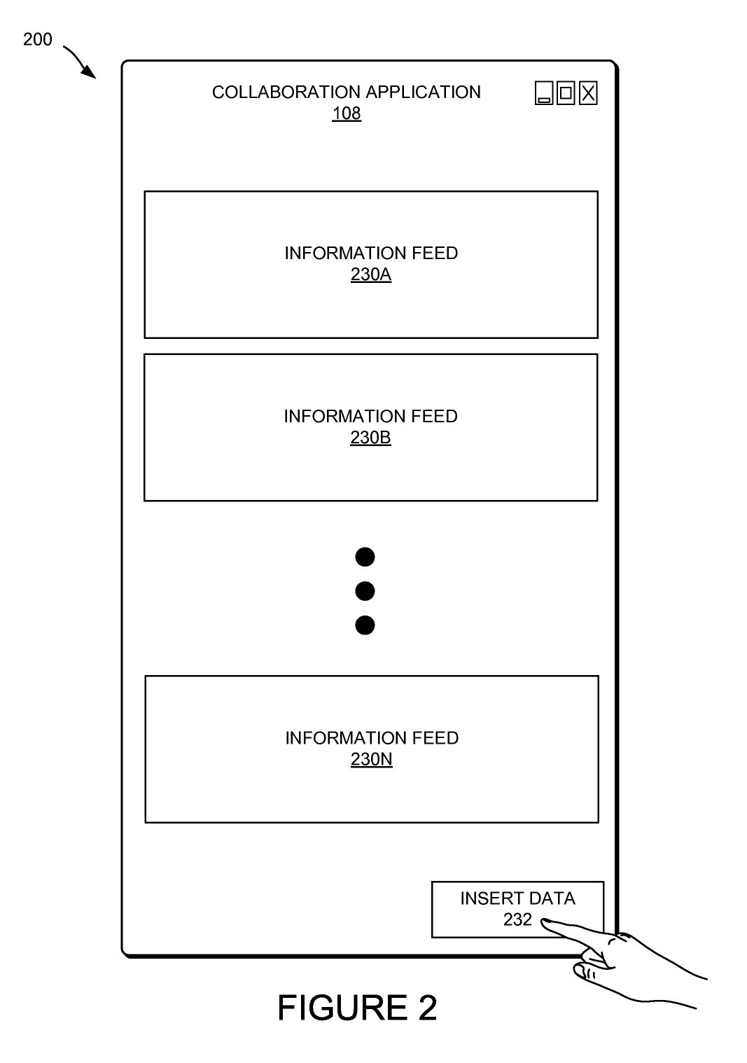

FIG. 2 is user interface (“UI”) diagram showing a user interface 200 for use in audio uploading and sharing using the collaboration application 108. When executed on device, such as the user device 102 of FIG. 1, the collaboration application 108 may cause the display of one or more information feeds 230A-230N (hereinafter referred to collectively and/or generically as “the information feeds 230” and individually as “the information feed 230A,” and the like). The information feeds 230 may be postings from a user of the collaboration application 108 or users using other collaboration applications, such as the collaboration application 112 executing on the user device 114. The information feeds 230 may be text, graphics, video, and the like.

A user may wish to have an audio file posted as an information feed 230 in the collaboration application 108 as well as the collaboration application 112. The collaboration application 108 may receive an input at an insert data interface 232. The insert data interface 232 may be configured to provide a user with the ability to insert various types of data as one of the information feeds 230. The various types of data may include, but are not limited to, audio, visual, textual, and the like. In the example provided herein, the data type is an audio file.

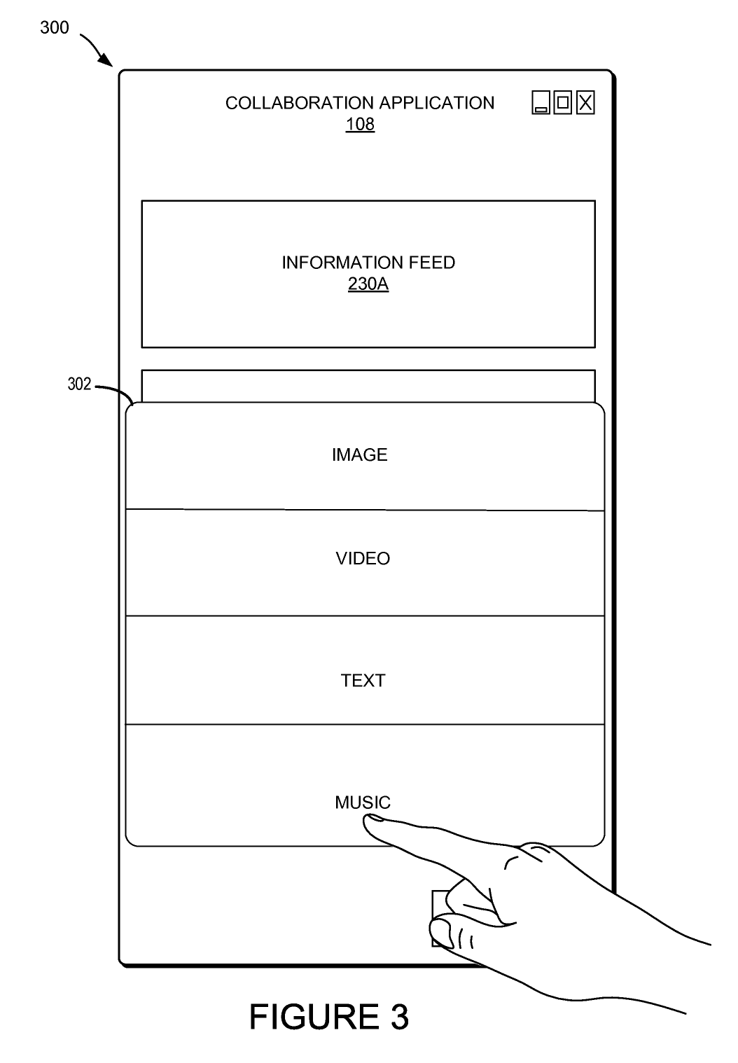

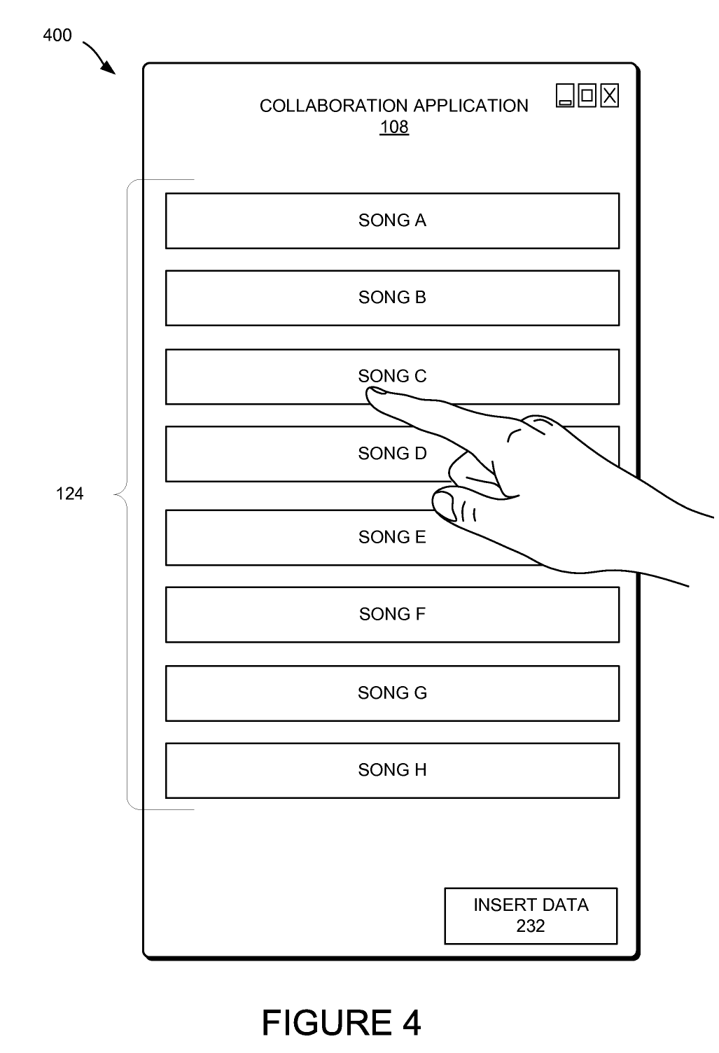

FIG. 3 is a user interface diagram showing a user interface 300 with a data type selection UI 302. Once an input is received at the insert data interface 232 of FIG. 2, the collaboration application 108 may initiate an insert data process. In an insert data process, the collaboration application 108 may cause the display of the data type selection UI 302. The data type selection UI 302 may include selectable boxes for selecting various types of data to insert. In the example illustrated in FIGURE, the types of data are “image,” “video,” “text,” and “music.” It should be appreciate that the types of data are merely exemplary. If the music data type is selected, the collaboration application may query the user device 102 to determine audio files to be inserted, described in more detail in FIG. 4.

FIG. 4 is a UI diagram showing the audio library 124. The audio library 124 may be generated when an input is received to insert an audio file into the information feed 230. The collaboration application 108 may query the audio data store 114 of the user device 102 to determine the audio files 116 available for sharing as the information feed 230. Once the audio files 116 are determined, the audio library 124 is generated.

In the example illustrated in FIG. 4, the audio library 124 indicates a listing of song A through song H. It should be appreciated that the audio library 124 may also include audio files such as music in addition to other types of audio files. The presently disclosed subject matter is not limited to any particular type of audio file.

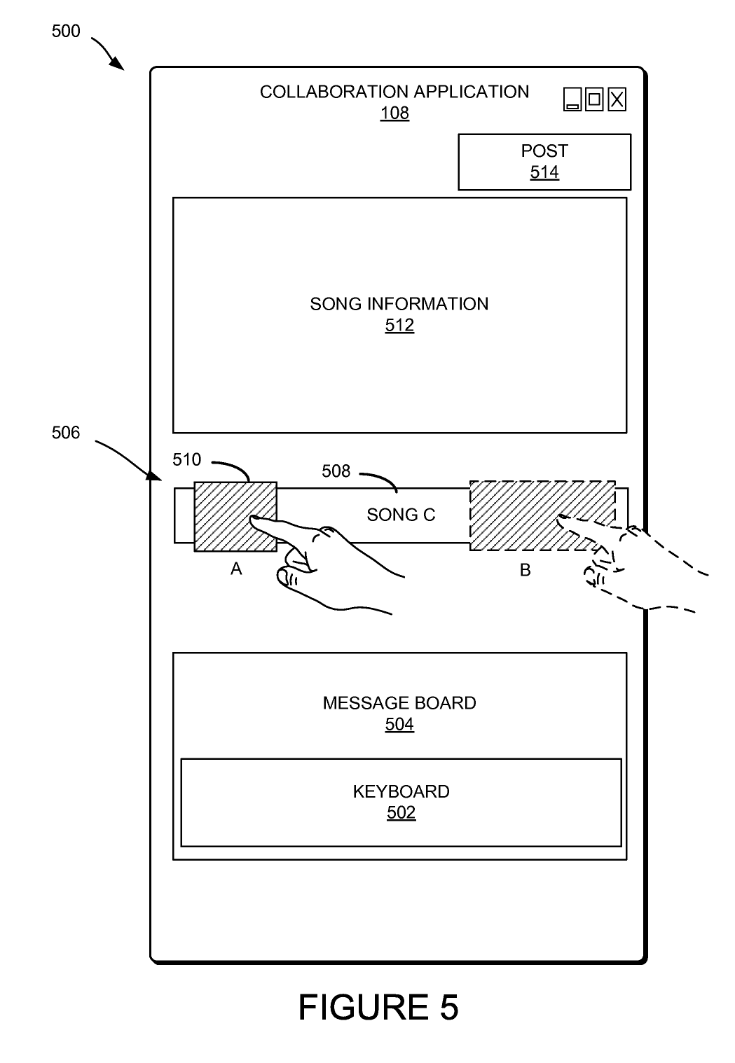

The listing of song A through song H in the audio library 124 may be selectable interfaces. In one example, a user may select “Song C,” which may be associated with the audio file 122B. The selection of the Song C may be an indication that the user wishes to insert Song C as one of the information feeds 230. Once selected, the user may be able to include additional information when the Song C is inserted as one of the information feeds 230, as shown in FIG. 5.

FIG. 5 is a UI diagram showing an audio insert interface 500. Upon the selection of a particular song, such as the Song C of FIG. 4, the collaboration application 108 may initiate the audio insert interface 500. The audio insert interface 500 may be used by a user to provide information along with the audio file 122B. For example, the user may be able to insert a message using a keyboard 502. The keyboard 502 may be configured to receive textual and/or graphical inputs from a user to place within a message display 504. The message display 504 may be displayed when the audio file 122B is inserted as one of the information feeds 230. For example, a user may insert the text, “Great song.” When the audio file 122B is inserted as one of the information feeds 230, the text “Great song” may be included as information in the information feed 230 associated with the audio file 122B.

The audio insert interface 500 may also be configured to allow a user to select a portion of the audio file 122B to insert. In some examples, it may be desirable to insert only a portion of the audio file 122B. For example, the use of only a portion of the audio file 122B may help reduce the amount of data transferred over the network 106. To allow a user to select a portion of the audio file 122B to insert, the audio insert interface 500 may include a portion selection interface 506. The portion selection interface 506 may include a time bar 508 and a selection indicator 510.

The time bar 508 may be an indicator showing the full length of the audio file 122B in a linear format. For example, the beginning of the time bar 508 may represent the beginning of the audio file 122B, the middle of the time bar 508 may represent a middle of the audio file 122B, and the end of the time bar 508 may represent the end of the audio file 122B.

The selection indicator 510 may represent the portion of the audio file 122B that will be uploaded and shared as one of the information feeds 230. The user may be able to move the selection indicator 510 to change which portion of the audio file 122B to be uploaded and shared. In the example illustrated in FIG. 5, the user has moved the selection indicator 510 from position A to position B. Thus, instead of the audio file 122B portion associated with the selection indicator 510 at position A being uploaded and shared, the audio file 122B portion associated with the selection indicator 510 at position B will be uploaded and shared.

In some examples, the amount of the portion of the audio file 122B to be shared can be changed. In the example illustrated in FIG. 5, at position A, the selection indicator 510 has a smaller length than the selection indicator at position B. At position B, the selection indicator 510 covers a greater amount of the audio file 122B. Thus, the length of the audio file 122B uploaded in relation to position B will be greater than the length of the audio file 122B uploaded in relation to position A.

The audio insert interface 500 also includes a song information display 512. The song information display 512 is configured to receive information from the audio file 122B and display the information. For example, the song information display 512 may include graphics associated with the audio file 122B such as, but not limited to, the title of the audio file 122B, artwork associated with an album to which the audio file 122B is associated with, and the like.

The audio insert interface 500 also includes a post interface 514. The post interface 514 is configured to receive an input from a user that the audio file 122B portion represented by the selection indicator 510, as well as other information such as the information displayed in the song information display 512, is to be posted as an information feed.

Upon receipt of the input to the post interface 514, the collaboration application 108 (of FIG. 1) may cause the user device 102 to access the audio data store 114 and create the portion file 122B 1 that includes the portion of the audio file 122B other information, such as the information in the song information display 512. The portion file 122B1 is uploaded to the server computer 104 for use by the collaboration application server 110. If posted to an information feed of the collaboration application 112 operating on the user device 114, the portion file 122B1 may be downloaded to the user device 114 and for access on the user device 114.

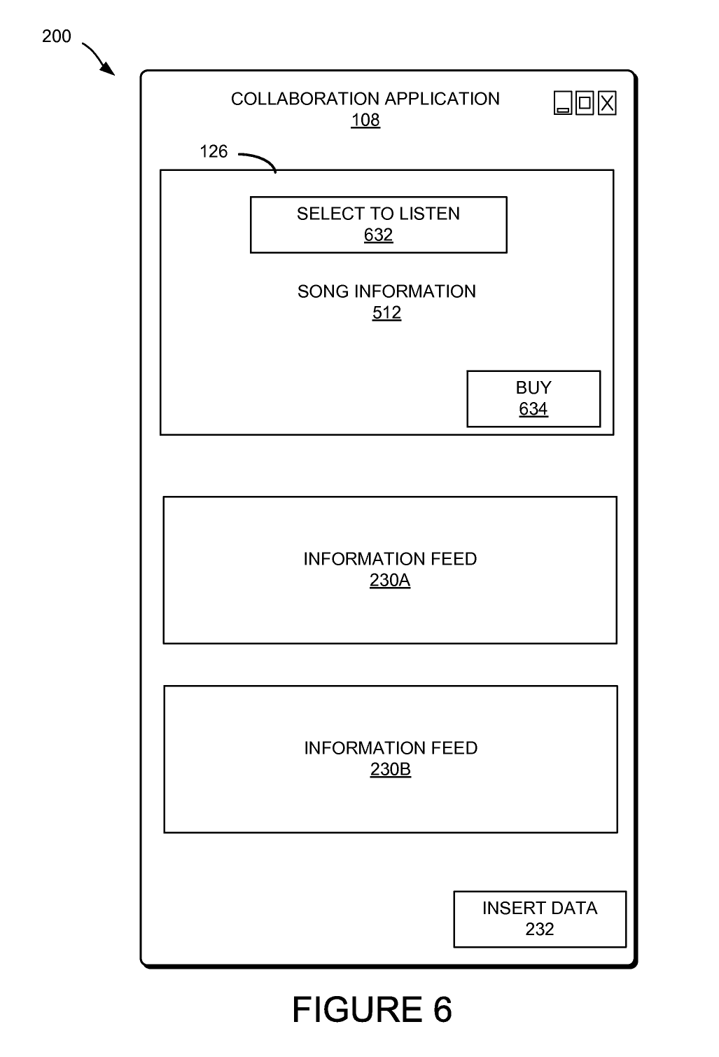

FIG. 6 is a UI diagram showing the UI 200 after the post interface 514 is selected. In FIG. 6, the portion file 122B1 has been inserted as the audio file feed 126 along with the information feed 230A and information feed 230B. The audio file feed 126 includes the song information 512. The audio file feed 126 also includes a select to listen interface 632. When an input is received at the select to listen interface 632, the audio component of the portion file 122B1 is played.

In some examples, the audio component of the portion file 122B1 may be played automatically. In other examples, the audio component of the portion file 122B1 may be played on a continuous loop until an input is received to stop the playback. The audio file feed 126 may also include a buy interface 634 in which a purchase of audio associated with the portion file 122B1 may be initiated with the audio store 118. It should be understood, however, that the buy interface 634 may not be present in some implementations.

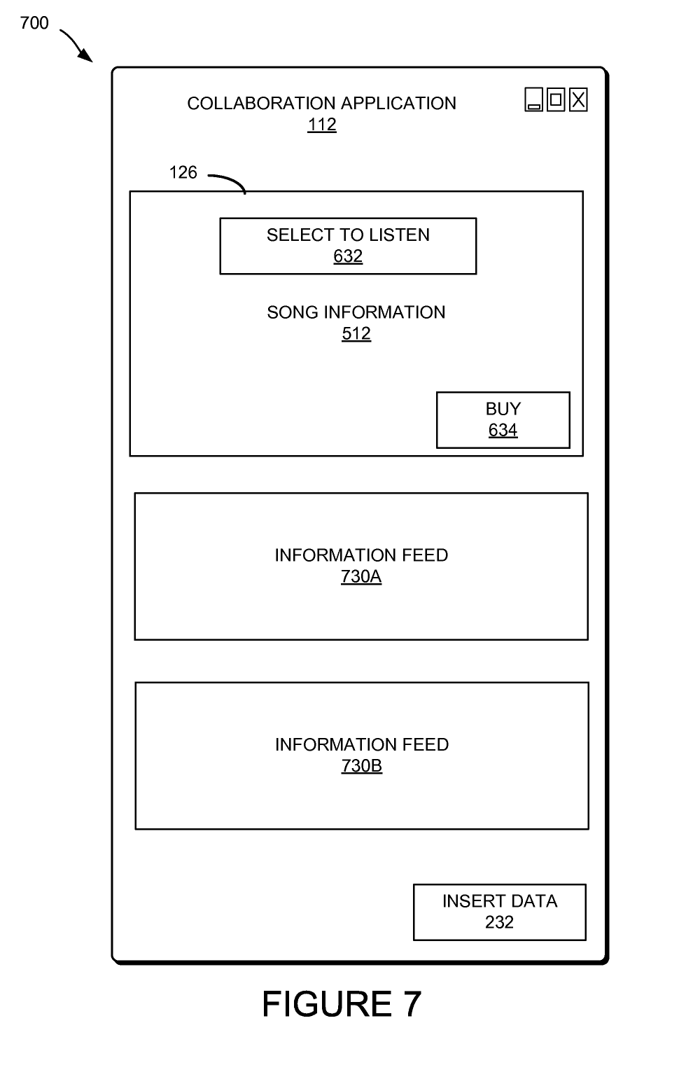

FIG. 7 is a UI diagram showing a UI 700 after the post interface 514 is selected. The UI 700 is associated with the user device 114 executing the collaboration application 112 after the user device 102 has uploaded the portion file 122B1. In FIG. 7, the portion file 122B1 has been inserted as the audio file feed 126 along with an information feed 630A and an information feed 630B. The audio file feed 126 includes the song information 512. In some examples, the song information 512 may include artist, title, and purchase price information. The audio file feed 126 also includes a select to listen interface 632. When an input is received at the select to listen interface 632, the audio component of the portion file 122B1 is played.

In some examples, the audio component of the portion file 122B1 may be played automatically. In other examples, the audio component of the portion file 122B1 may be played on a continuous loop until an input is received to stop the playback. The audio file feed 126 may also include a buy interface 634 in which a purchase of audio associated with the portion file 122B1 may be initiated with the audio store 118. It should be understood, however, that the buy interface 634, as with other interfaces and components, may not be present in some implementations. If an input is received at the audio file feed 126, the user device 114 may interface with the audio store 118 for the purchase of the audio file 122B.

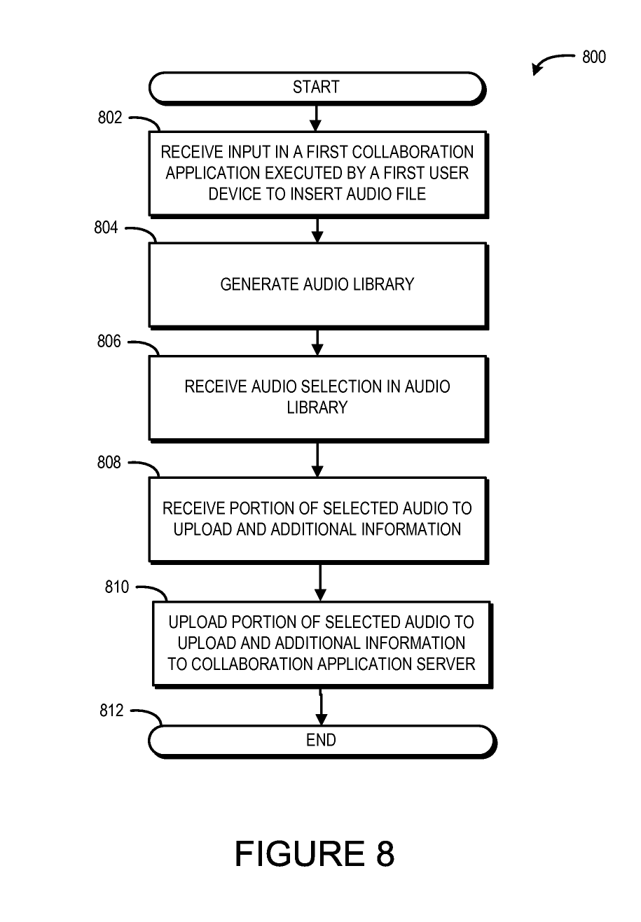

FIG. 8 is a flow diagram showing aspects of a method 800 for audio uploading and sharing using a social collaboration application, in accordance with some embodiments. It should be understood that the operations of the methods disclosed herein are not necessarily presented in any particular order and that performance of some or all of the operations in an alternative order(s) is possible and is contemplated. The operations have been presented in the demonstrated order for ease of description and illustration. Operations may be added, omitted, and/or performed simultaneously, without departing from the scope of the appended claims.

It also should be understood that the illustrated methods can be ended at any time and need not be performed in its entirety. Some or all operations of the methods, and/or substantially equivalent operations, can be performed by execution of computer-readable instructions included on a computer-storage media, as defined herein. The term “computer-readable instructions,” and variants thereof, as used in the description and claims, is used expansively herein to include routines, applications, application modules, program modules, programs, components, data structures, algorithms, and the like. Computer-readable instructions can be implemented on various system configurations, including single-processor or multiprocessor systems, minicomputers, mainframe computers, personal computers, hand-held computing devices, microprocessor-based, programmable consumer electronics, combinations thereof, and the like.

Thus, it should be appreciated that the logical operations described herein are implemented (1) as a sequence of computer implemented acts or program modules running on a computing system and/or (2) as interconnected machine logic circuits or circuit modules within the computing system. The implementation is a matter of choice dependent on the performance and other requirements of the computing system. Accordingly, the logical operations described herein are referred to variously as states, operations, structural devices, acts, or modules. These operations, structural devices, acts, and modules may be implemented in software, in firmware, in special purpose digital logic, and any combination thereof.

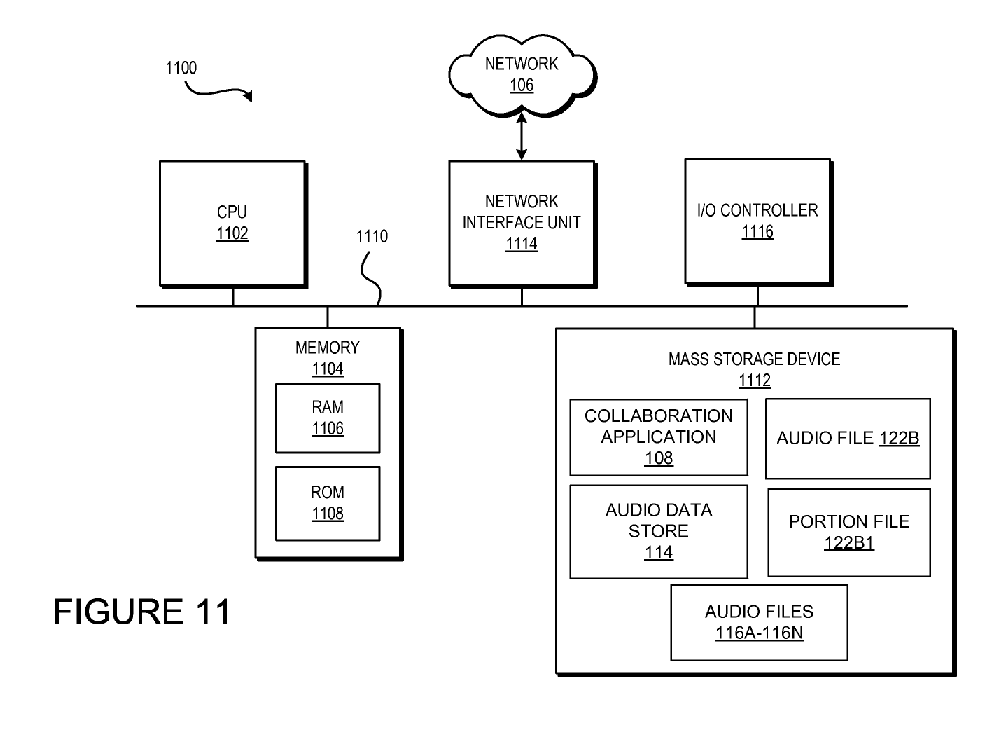

The operations of the method 800 are described herein below as being implemented, at least in part, by a computing device 1100 (described below with regard to FIG. 11). One or more of the operations of the method 800 may alternatively or additionally be implemented, at least in part, by the similar components in either computing device 1100 or a similarly configured server computer providing the operating environment 100.

Now with reference to FIG. 8, the method 800 begins and proceeds to operation 802, where an input is received at a first collaboration application executed by a first user device. The input may be an input to insert an audio file as an information feed in the first collaboration application, inserted as an audio file feed. The input may also be to insert the audio file as an information feed in a second collaboration application executing on a second user device that receives information feeds generated using the first collaboration application.

The method 800 proceeds to operation 804, where an audio library is generated. The audio library is a listing of audio files available for insertion as an audio file feed. The audio library may retrieve its listing by querying one or more data stores available to the collaboration application for searching. The audio file may, in some instances, include music.

The method 800 continues to operation 806, where an audio selection is received in the audio library. A user may scroll or search the audio library and select the audio file to be inserted as an audio file feed.

The method 800 proceeds to operation 808, where a portion of the the selected audio is uploaded along with additional information. The additional information may be information such as audio file playback length (or time), an artist associated with the audio file, a title of the audio file, and other information associated with the audio file.

The method 800 proceeds to operation 810, where the selected audio and additional information is uploaded to a collaboration application server. The method 800 thereafter ends at operation 812.

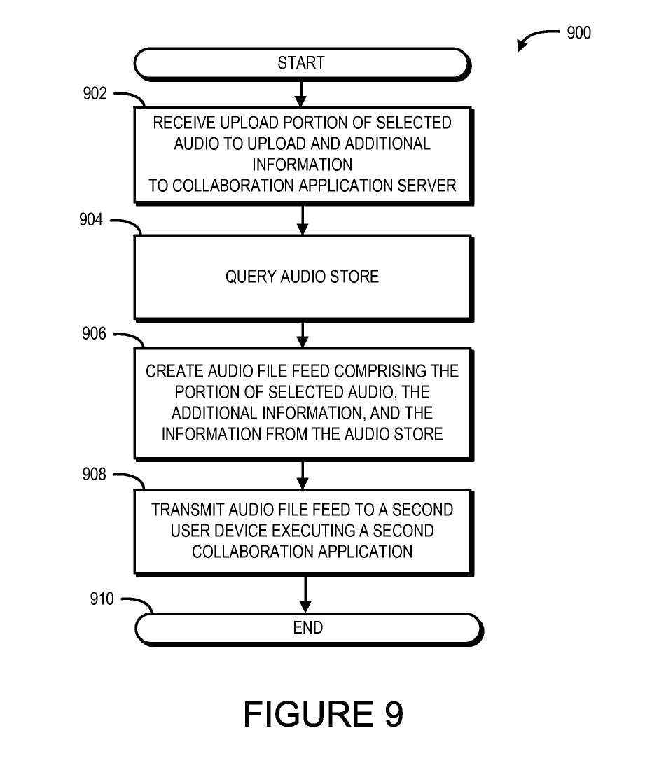

FIG. 9 is a flow diagram showing aspects of a method 900 for audio uploading and sharing using a social collaboration application in reference to the collaboration application server, in accordance with some embodiments.

The method 900 commences at operation 902, where the uploaded portion of the selected audio and additional information is received at the collaboration application server.

The method 900 proceeds to operation 904, where the collaboration application server queries an audio store associated with the selected audio. The additional information associated with the selected audio may contain metadata that identifies the audio store from which the purchase of the audio file was conducted.

The method 900 proceeds to operation 906, where an audio file feed is created. The audio file feed can include the portion of the selected audio, the additional information, and the information received from the audio store.

The method 900 proceeds to operation 908, where the audio file feed is transmitted to the second user device executing the second collaboration application. The method 800 thereafter ends at operation 910.

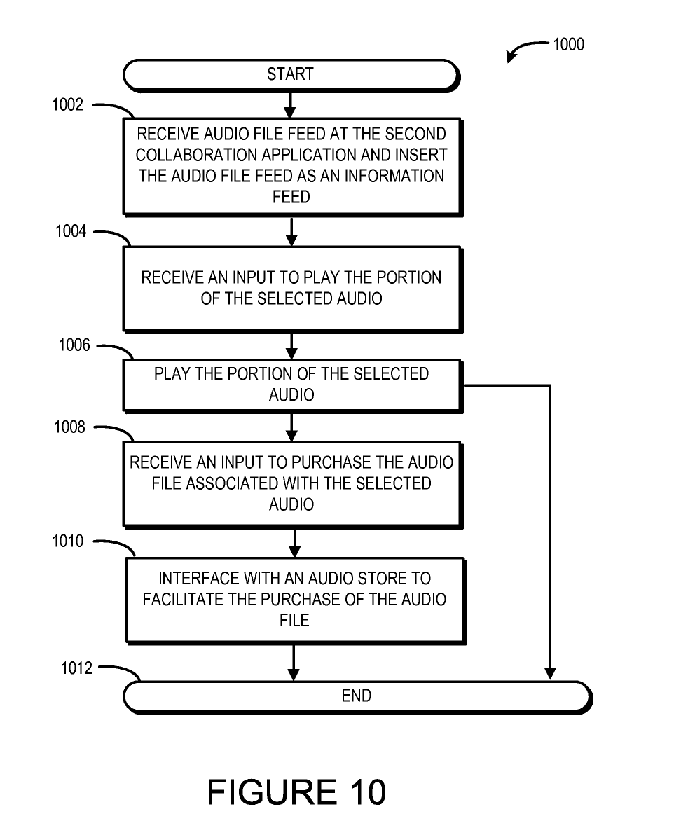

FIG. 10 is a flow diagram showing aspects of a method 1000 for audio uploading and sharing using a social collaboration application in reference to the second user device, in accordance with some embodiments.

The method 1000 commences at operation 1002, where the audio file feed is received at the second collaboration application executing on the second user device. The audio file feed is inserted into the second collaboration application as one of the information feeds displayed by the second collaboration application.

The method 1000 proceeds to operation 1004, where an input is received to play the portion of the selected audio. In some examples, the portion of the selected audio may play automatically at operation 1006. The method 1000 may thereafter end at operation 1012, or may continue to operation 1008.

The method 1000 proceeds to operation 1008, where an input is received to purchase the audio file associated with the portion of the selected audio.

The method 1000 proceeds to operation 1010, where the second collaboration application interfaces with the audio store to facilitate the purchase of the audio file. The method 1000 may thereafter end at operation 1012.

FIG. 11 illustrates an illustrative computer architecture 1100 for a device capable of executing the software components described herein for audio uploading and sharing using a social collaboration application. Thus, the computer architecture 1100 illustrated in FIG. 11 illustrates an architecture for a server computer, mobile phone, a PDA, a smart phone, a desktop computer, a netbook computer, a tablet computer, and/or a laptop computer. The computer architecture 1100 may be utilized to execute any aspects of the software components presented herein.

The computer architecture 1100 illustrated in FIG. 11 includes a central processing unit 1102 (“CPU”), a system memory 1104, including a random access memory 1106 (“RAM”) and a read-only memory (“ROM”) 1108, and a system bus 1110 that couples the memory 1104 to the CPU 1102. A basic input/output system containing the basic routines that help to transfer information between elements within the computer architecture 1100, such as during startup, is stored in the ROM 1108. The computer architecture 1100 further includes a mass storage device 1112 for storing the collaboration application 108, the audio data store 114, the audio files 116, the audio file 122B, and/or the portion file 122B1.

The mass storage device 1112 is communicatively connected to the CPU 1102 through a mass storage controller (not shown) connected to the bus 1110. The mass storage device 1112 and its associated computer-readable media provide non-volatile storage for the computer architecture 1100. Although the description of computer-readable media contained herein refers to a mass storage device, such as a hard disk or CD-ROM drive, it should be appreciated by those skilled in the art that computer-readable media can be any available computer storage media or communication media that can be accessed by the computer architecture 1100.

Communication media includes computer readable instructions, data structures, program modules, or other data in a modulated data signal such as a carrier wave or other transport mechanism and includes any delivery media. The term “modulated data signal” means a signal that has one or more of its characteristics changed or set in a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

By way of example, and not limitation, computer storage media may include volatile and non-volatile, removable and non-removable media implemented in any method or technology for storage of information such as computer-readable instructions, data structures, program modules or other data. For example, computer media includes, but is not limited to, RAM, ROM, EPROM, EEPROM, flash memory or other solid state memory technology, CD-ROM, digital versatile disks (“DVD”), HD-DVD, BLU-RAY, or other optical storage, magnetic cassettes, magnetic tape, magnetic disk storage or other magnetic storage devices, or any other medium which can be used to store the desired information and which can be accessed by the computer architecture 1100. For purposes the claims, the phrase “computer storage medium” and variations thereof, does not include waves, signals, and/or other transitory and/or intangible communication media, per se.

According to various embodiments, the computer architecture 1100 may operate in a networked environment using logical connections to remote computers through a network such as the network 106. The computer architecture 1100 may connect to the network 106 through a network interface unit 1114 connected to the bus 1110. It should be appreciated that the network interface unit 1114 also may be utilized to connect to other types of networks and remote computer systems, for example, the audio store 118. The computer architecture 1100 also may include an input/output controller 1116 for receiving and processing input from a number of other devices, including a keyboard, mouse, or electronic stylus (not shown in FIG. 11). Similarly, the input/output controller 1116 may provide output to a display screen, a printer, or other type of output device (also not shown in FIG. 11).

It should be appreciated that the software components described herein may, when loaded into the CPU 1102 and executed, transform the CPU 1102 and the overall computer architecture 1100 from a general-purpose computing system into a special-purpose computing system customized to facilitate the functionality presented herein. The CPU 1102 may be constructed from any number of transistors or other discrete circuit elements, which may individually or collectively assume any number of states. More specifically, the CPU 1102 may operate as a finite-state machine, in response to executable instructions contained within the software modules disclosed herein. These computer-executable instructions may transform the CPU 1102 by specifying how the CPU 1102 transitions between states, thereby transforming the transistors or other discrete hardware elements constituting the CPU 1102.

Encoding the software modules presented herein also may transform the physical structure of the computer-readable media presented herein. The specific transformation of physical structure may depend on various factors, in different implementations of this description. Examples of such factors may include, but are not limited to, the technology used to implement the computer-readable media, whether the computer-readable media is characterized as primary or secondary storage, and the like. For example, if the computer-readable media is implemented as semiconductor-based memory, the software disclosed herein may be encoded on the computer-readable media by transforming the physical state of the semiconductor memory. For example, the software may transform the state of transistors, capacitors, or other discrete circuit elements constituting the semiconductor memory. The software also may transform the physical state of such components in order to store data thereupon.

As another example, the computer-readable media disclosed herein may be implemented using magnetic or optical technology. In such implementations, the software presented herein may transform the physical state of magnetic or optical media, when the software is encoded therein. These transformations may include altering the magnetic characteristics of particular locations within given magnetic media. These transformations also may include altering the physical features or characteristics of particular locations within given optical media, to change the optical characteristics of those locations. Other transformations of physical media are possible without departing from the scope and spirit of the present description, with the foregoing examples provided only to facilitate this discussion.

In light of the above, it should be appreciated that many types of physical transformations take place in the computer architecture 1100 in order to store and execute the components presented herein. It also should be appreciated that the computer architecture 1100 may include other types of computing devices, including hand-held computers, embedded computer systems, personal digital assistants, and other types of computing devices known to those skilled in the art. It is also contemplated that the computer architecture 1100 may not include all of the components shown in FIG. 11, may include other components that are not explicitly shown in FIG. 11, or may utilize an architecture completely different than that shown in FIG. 11.

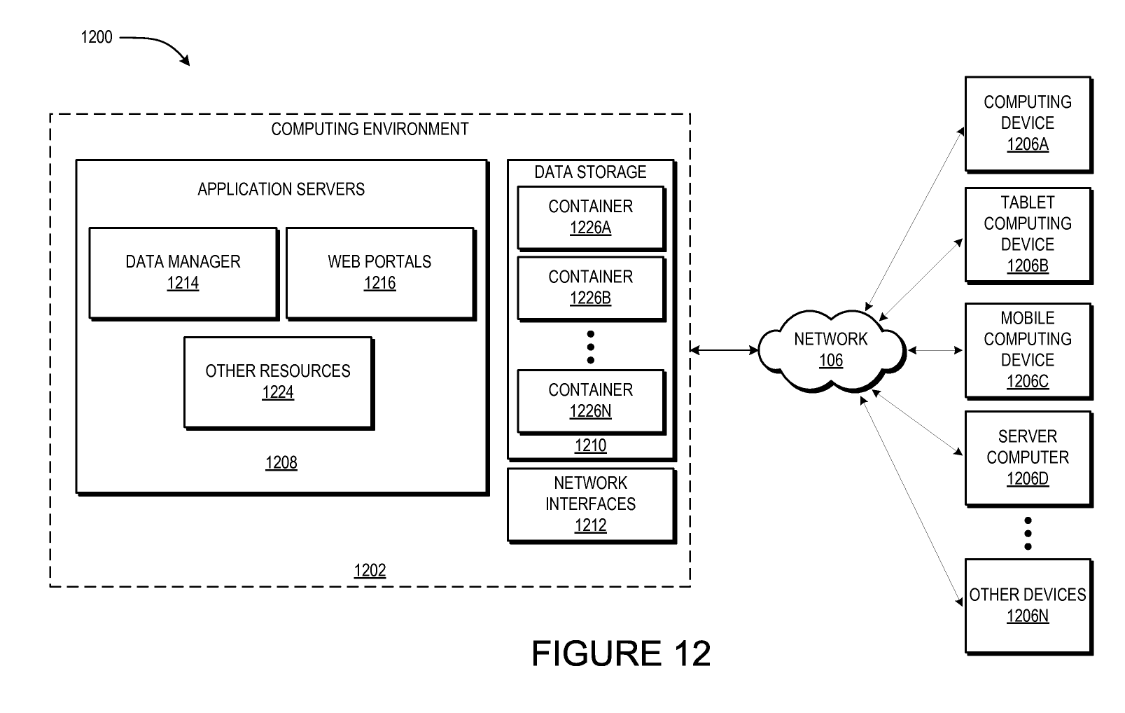

FIG. 12 illustrates an illustrative distributed computing environment 1200 capable of executing the software components described herein for audio uploading and sharing using a social collaboration application, in accordance with some embodiments. Thus, the distributed computing environment 1200 illustrated in FIG. 12 can be used to provide the functionality described herein with respect to the user device 102, the server computer 104, and/or the user device 114. The distributed computing environment 1200 thus may be utilized to execute any aspects of the software components presented herein.

According to various implementations, the distributed computing environment 1200 includes a computing environment 1202 operating on, in communication with, or as part of the network 106. The network 106 also can include various access networks. One or more client devices 1206A-1206N (hereinafter referred to collectively and/or generically as “clients 1206”) can communicate with the computing environment 1202 via the network 106 and/or other connections (not illustrated in FIG. 12). In the illustrated embodiment, the clients 1206 include a computing device 1206A such as a laptop computer, a desktop computer, or other computing device; a slate or tablet computing device (“tablet computing device”) 1206B; a mobile computing device 1206C such as a mobile telephone, a smart phone, or other mobile computing device; a server computer 1206D; and/or other devices 1206N. It should be understood that any number of clients 1206 can communicate with the computing environment 1202. It should be understood that the illustrated clients 1206 and computing architectures illustrated and described herein are illustrative, and should not be construed as being limited in any way.

In the illustrated embodiment, the computing environment 1202 includes application servers 1208, data storage 1210, and one or more network interfaces 1212. According to various implementations, the functionality of the application servers 1208 can be provided by one or more server computers that are executing as part of, or in communication with, the network 1204. The application servers 1208 can host various services, virtual machines, portals, and/or other resources. In the illustrated embodiment, the application servers 1208 host one or more virtual machines 1214 for hosting applications or other functionality. According to various implementations, the virtual machines 1214 host one or more applications and/or software modules for providing the functionality described herein for use in audio uploading and sharing using the collaboration application. It should be understood that this embodiment is illustrative, and should not be construed as being limiting in any way. The application servers 1208 also host or provide access to one or more Web portals, link pages, Web sites, and/or other information (“Web portals”) 1216.

As shown in FIG. 12, the application servers 1208 also can host other services, applications, portals, and/or other resources (“other resources”) 1224. It thus can be appreciated that the computing environment 1202 can provide integration of the concepts and technologies disclosed herein provided herein for use in audio uploading and sharing using the collaboration application. It should be understood that these embodiments are illustrative, and should not be construed as being limiting in any way.

As mentioned above, the computing environment 1202 can include the data storage 1210. According to various implementations, the functionality of the data storage 1210 is provided by one or more databases operating on, or in communication with, the network 1204. The functionality of the data storage 1210 also can be provided by one or more server computers configured to host data for the computing environment 1202. The data storage 1210 can include, host, or provide one or more real or virtual datastores 1226A-1226N (hereinafter referred to collectively and/or generically as “datastores 1226”). The datastores 1226 are configured to host data used or created by the application servers 1208 and/or other data.

The computing environment 1202 can communicate with, or be accessed by, the network interfaces 1212. The network interfaces 1212 can include various types of network hardware and software for supporting communications between two or more computing devices including, but not limited to, the clients 1206 and the application servers 1208. It should be appreciated that the network interfaces 1212 also may be utilized to connect to other types of networks and/or computer systems.

It should be understood that the distributed computing environment 1200 described herein can provide any aspects of the software elements described herein with any number of virtual computing resources and/or other distributed computing functionality that can be configured to execute any aspects of the software components disclosed herein. According to various implementations of the concepts and technologies disclosed herein, the distributed computing environment 1200 provides the software functionality described herein as a service to the clients 1206. It should be understood that the clients 1206 can include real or virtual machines including, but not limited to, server computers, web servers, personal computers, mobile computing devices, smart phones, and/or other devices. As such, various embodiments of the concepts and technologies disclosed herein enable any device configured to access the distributed computing environment 1200 to utilize the functionality described herein for use in audio uploading and sharing using the collaboration application.

Based on the foregoing, it should be appreciated that technologies for use in audio uploading and sharing using the collaboration application have been disclosed herein. Although the subject matter presented herein has been described in language specific to computer structural features, methodological and transformative acts, specific computing machinery, and computer readable media, it is to be understood that the invention defined in the appended claims is not necessarily limited to the specific features, acts, or media described herein. Rather, the specific features, acts and mediums are disclosed as example forms of implementing the claims.

The subject matter described above is provided by way of illustration only and should not be construed as limiting. Various modifications and changes may be made to the subject matter described herein without following the example embodiments and applications illustrated and described, and without departing from the true spirit and scope of the present invention, which is set forth in the following claims.

What is claimed is:

1. A computer-implemented method, comprising:
receiving an input at a first collaboration application to share a portion of an audio file with a second collaboration application as an information feed in the second collaboration application;
generating an audio library;
receiving a selection of an audio file as a selected audio file to share from the audio library;
receiving a selection of a portion of the selected audio file; and
uploading the portion of the selected audio file to a collaboration application server to generate an audio file feed to be transmitted to the second collaboration application.

2. The computer-implemented method of claim 1, wherein the audio file comprises a song and additional information about the song.

3. The computer-implemented method of claim 2, wherein the additional information about the song comprises a name of an artist, a name of the song, artwork associated with the song, or an audio store from which a right to download or play the song was purchased.

4. The computer-implemented method of claim 1, further comprising receiving the audio file feed comprising the portion of the selected audio file.

5. The computer-implemented method of claim 4, further comprising inserting the audio file feed into the first collaboration application as an information feed in the first collaboration application.

6. The computer-implemented method of claim 1, wherein generating the audio library comprises querying an audio data store for a plurality of audio files available for sharing.

7. The computer-implemented method of claim 1, further comprising receiving an input of additional information from a user to include with the audio file feed.

8. The computer-implemented method of claim 1, wherein receiving the selection of the portion of the selected audio file comprises:
displaying a time bar that indicates a full length of the selected audio file in a linear format; and
displaying a selection indicator over the time bar representing the portion of the selected audio file that will be uploaded when selected.

9. The computer-implemented method of claim 8, wherein the selection indicator is movable over a length of the time bar.

10. The computer-implemented method of claim 8, wherein the selection indicator is reconfigurable to change an amount of the selected audio file that will be uploaded when selected.

11. A computer-readable storage medium having computer-executable instructions stored thereupon which, when executed by one or more processors, cause the one or more processors to:
receive an input at a first collaboration application to share a portion of an audio file with a second collaboration application as an information feed in the second collaboration application;
generate an audio library;
receive a selection of an audio file as a selected audio file to share from the audio library;
receive a selection of a portion of the selected audio file; and
upload the portion of the selected audio file to a collaboration application server to generate an audio file feed to be transmitted to the second collaboration application.

12. The computer-readable storage medium of claim 11, wherein the audio file comprises a song and additional information about the song.

13. The computer-readable storage medium of claim 12, wherein the additional information about the song comprises a name of an artist, a name of the song, artwork associated with the song, or an audio store from which a right to download or play the song was purchased.

14. The computer-readable storage medium of claim 11, further comprising computer-executable instructions to receive the audio file feed comprising the portion of the selected audio file.

15. The computer-readable storage medium of claim 14, further comprising computer-executable instructions to insert the audio file feed into the first collaboration application as an information feed in the first collaboration application.

16. The computer-readable storage medium of claim 11, wherein the computer-executable instructions to generate the audio library comprises computer-executable instructions to query an audio data store for a plurality of audio files available for sharing.

17. The computer-readable storage medium of claim 11, further comprising computer-executable instructions to receive an input of additional information from a user to include with the audio file feed.

18. The computer-readable storage medium of claim 11, wherein the computer-executable instructions to receive the selection of the portion of the selected audio file comprises computer-executable instructions to:
display a time bar that indicates a full length of the selected audio file in a linear format; and
display a selection indicator over the time bar representing the portion of the selected audio file that will be uploaded when selected.

18. A computing system, the computing system comprising:
a processor; and
a computer-readable storage medium having computer-executable instructions stored thereupon which, when executed on the processor, cause the processor to
receive at a first collaboration application an audio file feed comprising a portion of a selected audio file generated at a first collaboration application;
insert the audio file feed as an information feed in the first collaboration application; and
receive an input to play the portion of the selected audio file.

19. The computing system of claim 18, wherein the computer-readable storage medium further comprises computer-executable instructions to:
receive an input to purchase a right to download and play an audio file associated with the portion of the selected audio file;
communicate with an audio store to facilitate the purchase of the right; and
receive from the audio store the audio file.

20. The computing system of claim 19, wherein the portion of the selected audio file comprises an identification of the audio store.
